(19) United States
(12) Patent Application Publication
(10) Pub. No.: US 2024/0006899 A1
(43) Pub. Date: Jan. 4, 2024

(54) Removable Battery Pack with at least one Switching Element for Interrupting or Enabling a Charging or Discharging Current

(71) Applicant: Robert Bosch GmbH, Stuttgart (DE)

(72) Inventor: Holger Wernerus, Pliezhausen (DE)

(21) Appl. No.: 18/254,790

(22) PCT Filed: Nov. 3, 2021
(86) PCT No.: PCT/EP2021/080457

§ 371 Date: May 26, 2023

(30) Foreign Application Priority Data
Nov. 30, 2020 (DE) 10 2020 215 037.0

(51) Int. Cl. H02J 7/00; H01M 10/42; H01M 10/48

(52) U.S. Cl. CPC H02J 7/0045; H01M 10/425; H01M 10/486; H02J 7/00308; H01M 2220/30

(57) ABSTRACT

A removable battery pack includes an electromechanical interface and a measuring circuit. The electromechanical interface includes a plurality of electrical contacts. A first of the electrical contacts serves as a first power supply contact to which a first reference potential is applied, and a second of the electrical contacts serves as a second power supply contact to which a second reference potential is applied. The electromechanical interface further includes at least one first switching element configured to interrupt or enable a charging or discharging current across the first and second power supply contacts. The measuring circuit is configured to measure integrated components which are integrated in the removable battery pack, via at least one further contact of the electromechanical interface, which further contact is configured as a signal contact or data contact. The measuring circuit is interconnected with the second contact, which is configured as the second power supply contact.

The invention relates to a removable battery pack with at least one switching element for interrupting or enabling a charging or discharging current according to the preamble of claim 1.

### THE PRIOR ART

A large number of electrical consumers are operated using exchangeable battery packs requiring no tool use by the user (hereinafter referred to as removable battery packs), which are accordingly discharged by the electrical consumer and can be recharged using a charging device. Typically, such removable battery packs consist of a plurality of energy store cells interconnected in series and/or parallel in order to achieve a required removable battery pack voltage or capacity. If the energy store cells are designed as, e.g., lithium ion cells (Li-ion), a particularly advantageous, quite high power and energy density can be achieved.

It known to design an electromechanical battery pack interface to be detachable without the use of tools from a further electromechanical interface of the electrical consumer or charging device. A respective one first electrical contact of the interfaces is in this case designed as an energy supply contact which can be supplied with a first reference potential, preferably a supply potential, and a respective one second electrical contact of the battery interfaces serves as an energy supply contact which can be supplied with a second reference potential, preferably a ground potential. It is further known from DE 10 2011 053 830 B4 to equip a removable battery pack with a switching element in the current path in order to interrupt or enable a charging or discharging current.

Proceeding from the prior art, the problem addressed by the invention is to determine, reliably and error-free, charging or discharging parameters of the removable battery pack, e.g., a temperature of a temperature measuring sensor, a resistor value of a coding resistor, or the like, as far as possible independently of the charging or discharging current via an electrical consumer connected to the removable battery pack or a charging device connected to the removable battery pack across corresponding signal contacts or data contacts.

### ADVANTAGES OF THE INVENTION

In order to solve this problem, it is provided that the removable battery pack comprises a measuring circuit for measuring components, which are integrated in the removable battery pack, via at least one further contact of the electromechanical interface, which further contact is designed as a signal contact or data contact, the measuring circuit being interconnected with the second contact, which is designed as a power supply contact, in such a way that the integrated components are measured substantially independently of the charging or discharging current of the removable battery pack. Particularly advantageously, given the proximity of the ground-side connection of the components being measured to the corresponding power supply contact of the electromechanical interface (and the avoidance of undesirable voltage drops within the measuring loop thereby), it is possible to reliably determine the charging or discharging parameters at any desired charging or discharging currents.

Electrical consumers in the context of the invention should be understood to mean, e.g., power tools that can be operated using a removable battery pack for machining workpieces by means of an electrically driven insertion tool. The power tool can in this case be designed both as a hand-held power tool, or also as a stationary electric machine tool. Typical power tools in this context include hand or bench drills, screwdrivers, percussion drills, hammer drills, planers, angle grinders, orbital sanders, polishing machines, circular saws, table saws, crosscut saws and jigsaws, or the like. However, garden and construction equipment operated using a removable battery pack such as lawnmowers, lawn trimmers, branch saws, motor and ditching mills, robotic breakers and excavators, or the like, as well as household equipment operated with a removable battery pack such as vacuum cleaners, mixers, etc., can also be considered as electrical consumers. The invention is likewise applicable to electrical consumers which are simultaneously supplied using a plurality of removable battery packs.

The voltage of a removable battery pack is typically a multiple of the voltage of a single energy store cell and results from the interconnection (parallel or in series) of the individual energy store cells. An energy store cell is typically designed as a galvanic cell comprising a structure in which a cell pole comes to rest on one end and another cell pole comes to rest on an opposite end. In particular, the energy store cell comprises a positive cell pole at one end and a negative cell pole at an opposite end. Preferably, the energy store cells are formed as lithium-based energy store cells, e.g., Li-ion, Li-po, Li-metal, or the like. However, the invention can also be applied to removable battery packs having Ni—Cd, Ni—MH cells, or other suitable cell types. In conventional Li-ion energy store cells with a cell voltage of 3.6 V, voltage classes result of, e.g., 3.6 V, 7.2 V, 10.8 V, 14.4 V, 18 V, 36 V, etc. Preferably, an energy store cell is designed as an at least substantially cylindrical round cell, the cell poles being arranged at ends of the cylindrical shape. However, the invention does not depend on the type and design of the energy store cells used, but can instead be applied to any removable battery packs and energy store cells, e.g. pouch cells or the like, in addition to round cells.

It is further provided that a monitoring unit of the removable battery pack opens the at least one switching element, which is interconnected with the second reference potential, preferably the ground potential, in order to interrupt the charging or discharging current and closes it in order to enable the charging or discharging current. If the at least one first switching element is opened in order to interrupt the charging or discharging current of the removable battery pack, there is a risk of a permanently high voltage drop across the at least one first switching element, which can reach up to the level of the removable battery voltage, e.g., when an external load is connected, e.g., an electrical consumer or a charging device. Due to inductive components in the current path, the voltage drop can also be significantly higher for a short time after the opening of the at least one first switching element. This voltage drop can lead to damage or functional impairment in the removable battery pack and/or in the load. In order to avoid such a drop in voltage, a further embodiment of the invention provides that at least one further switching element is provided between the measuring circuit and the second contact, which is designed as a power supply contact, in order to avoid a current flow proceeding from the second reference potential, preferably the ground potential, into the measuring circuit or from the measuring circuit towards the second reference potential, preferably the ground potential. In addition, risks that could affect the functionality of the removable battery pack, electrical consumer, and/or charging device can be avoided.

In order to protect the measuring circuit from excessive voltages, the monitoring unit separates it from the second reference potential, preferably from the ground potential, by opening the at least one further switching element in a time-dependent manner before the at least one first switching element. It is further provided that the monitoring unit closes the at least one further switching element in a time-dependent manner after the at least one first switching element in order to ensure that, after closing the at least one first switching element, any voltage that drops across it can first degrade.

As an alternative to the at least one further switching element or also in addition thereto, a control input of the measuring circuit can be decoupled from the monitoring unit by a protection element, in particular a protection diode. In this way, other components of the removable battery pack connected to the measuring circuit, such as the monitoring unit, can be protected against excessive voltages or voltage spikes. It is also conceivable that these components and/or the measuring circuit itself be designed from the outset such that they can absorb these high voltages.

Furthermore, the at least one further contact designed as a signal contact or data contact of the electromechanical interface can be decoupled by a protection element, in particular a protection diode, in order to be protect devices that are externally connected via the signal contacts or data contacts against excessive voltages or voltage spikes of the removable battery pack. This decoupling process can alternatively or additionally also be performed in the external device.

### EXEMPLARY EMBODIMENTS

### Drawings

The invention is explained below with reference to FIGS. 1 to 3 by way of example, whereby identical reference characters in the drawings indicate identical components having an identical function.

Shown are:

FIG. 1: a schematic view of system comprising at least one removable battery pack and at least one charging device connectable to the removable battery pack for charging, or an electrical consumer connectable to the removable battery pack for discharging the removable battery pack,

FIG. 2: a block diagram of the system of FIG. 1 in a first exemplary embodiment, and

FIG. 3: a block diagram of the system of FIG. 1 in a second exemplary embodiment.

### DESCRIPTION OF THE EXEMPLARY EMBODIMENTS

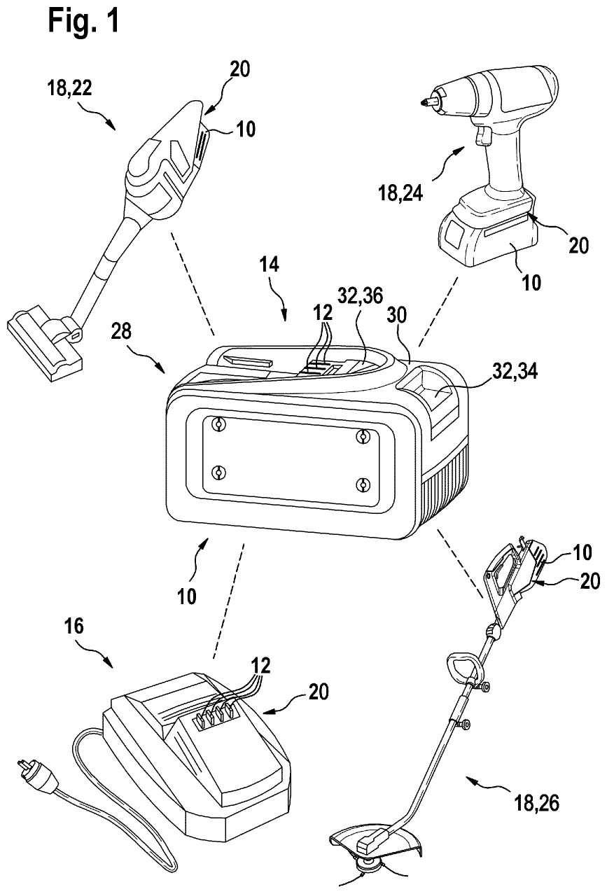

FIG. 1 shows a removable battery pack 10 with an electromechanical interface 14 having a plurality of electrical contacts 12. The removable battery pack 10 can be charged by means of a charging device 16 and discharged by various electrical consumers 18. To this end, the charging device 16 and the electrical consumers 18 each comprise a further electromechanical interface 20 having a plurality of electrical contacts 12. FIG. 1 is intended to illustrate that the invention is suitable for various electrical consumers 18. By way of example, a battery vacuum cleaner 22, a battery impact wrench 24, and a battery lawn trimmer 26 are shown. However, in the context of the invention, a wide variety of power tools, garden tools, and household appliances can be suitable as electrical consumers 18.

The removable battery pack 10 comprises a housing 28, a side wall or top side 30 of which comprises the electromechanical interface 14 for detachable connection with the further electromechanical interface 20 of the charging device 16 or the electrical consumers 18. In connection with the electrical consumer 18, the electromechanical interfaces 14, 20 are primarily used to discharge the removable battery pack 10, while, in connection with the charging device 16, they are used in order to charge the removable battery pack 10. The exact design of the electromechanical interfaces 14, 20 depends on various factors, such as the voltage class of the removable battery pack 10, or of the electrical consumer 18, and various manufacturer specifications. For example, it is also possible to provide three or more electrical contacts 12 for energy and/or data transmission between the removable battery pack 10 and the charging device 16. or the electrical consumer 18. A mechanical coding is also conceivable so that the removable battery pack 10 can be operated only on specific electrical consumers 18. Given that the mechanical design of the electromechanical interface 14 of the removable battery pack 10 and of the further electromechanical interface 20 of the charging device 16 or the electrical consumer 18 is irrelevant to the invention, it will not be discussed in further detail. Both the skilled person and a user of the removable battery pack 10 and of the charging device 16, or rather the electrical consumer 18, will make the appropriate selection in this respect.

The removable battery pack 10 comprises a mechanical locking device 32 for locking the positively and/or non-positively detachable connection of the electromechanical interface 14 of the removable battery pack 10 to the corresponding counter-interface 20 (not shown in detail) of the electrical consumer 18. The locking device 32 is in this case designed as a spring-loaded push button 34 that is operatively connected to a locking element 36 of the removable battery pack 10. Due to the spring of the push button 34 and/or of the locking element 36, the locking device 32 automatically engages into the counter-interface 20 of the electrical consumer 18 upon insertion of the removable battery pack 10. If a user presses the push button 34 in the insertion direction, the locking is released and the user can remove or extend the removable battery pack 10 from the electrical consumer 18 in the direction opposite the insertion direction.

As previously mentioned hereinabove, the battery voltage of the removable battery pack 10 generally results from a multiple of the individual voltages of the energy store cells (not shown) as a function of their connection (in parallel or in series). Preferably, the energy store cells are designed as lithium-based energy store cells, e.g., Li-ion, Li-po, Li-metal, or the like. However, the invention can also be applied to removable battery packs having Ni—Cd, Ni—MH cells, or other suitable cell types.

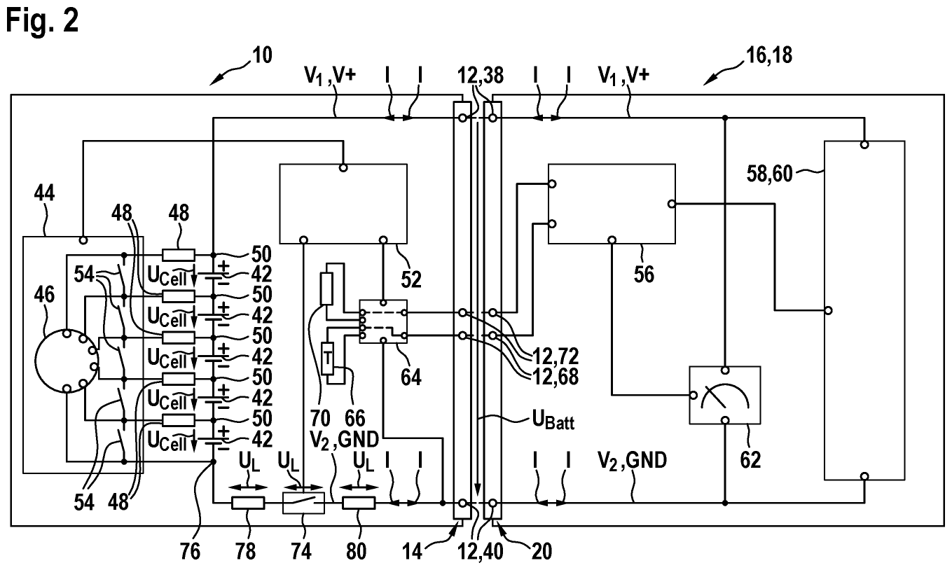

FIG. 2 shows a block diagram consisting of the removable battery pack 10 on the left side and a charging device 16, or rather the electrical consumer 18, on the right side. The removable battery pack 10 and charging device 16 (or electrical consumer 18) comprise the mutually corresponding electromechanical interfaces 14 and 20 having a plurality of electrical contacts 12, a respective one first electrical contact 12 of the interfaces 14, 20 serving as an energy supply contact 38 which can be supplied with a first reference potential V₁, preferably a supply potential V₊, and a respective one second electrical contact 12 of the battery interfaces 14, 20 serving as an energy supply contact 40 which can be supplied with a second reference potential V₂, preferably a ground potential GND. Via the first and the second energy supply contacts 38, 40, the removable battery pack 10 can, on the one hand, be charged by the charging device 16 with a charging current and, on the other hand, discharged by the electrical consumer 18 with a discharging current. The current strengths of the charge and the discharging current can differ significantly from one another. The discharging current in correspondingly designed electrical consumers 18 can be up to 10 times higher than the charging current of the charging device 16. The common symbol I will be used hereinafter despite these differences between charge and discharging current. The phrase “can be supplied” is intended to clarify that the potentials V₊ and GND, in particular in the case of an electrical consumer 18, are not permanently applied to the energy supply contacts 38, 40 but are only applied after connecting the electrical interfaces 14, 20. The same is true of a discharged removable battery pack 10 after connection to the charging device 16.

The removable battery pack 10 comprises a plurality of energy store cells 42, which are shown in FIG. 2 as a series circuit but can alternatively or additionally also be operated in a parallel circuit, in which case the series circuit defines the voltage UBatt of the removable battery pack 10 dropping across the energy supply contacts 38, 40, while a parallel circuit of individual energy store cells 42 primarily increases the capacity of the removable battery pack 10. As previously mentioned hereinabove, it is also possible to connect in series individual cell clusters consisting of energy store cells 42 connected in parallel in order to achieve a specific voltage U_{Batt} of the removable battery pack with simultaneously increased capacity. In conventional Li-ion energy store cells 42 with a cell voltage U_{Cell} of 3.6 V each, a removable battery pack voltage U_{Batt}=V₁−V₂ of 5·3.6 V=18 V drops across the energy supply contacts 38, 40 in the present exemplary embodiment. Depending on the number of energy store cells 42 connected in parallel in a cell cluster, the capacity of conventional removable battery packs 10 can be up to 12 Ah or more. However, the invention is not dependent on the type, design, voltage, power supply capability, etc. of the energy storage cells 42 used, but can be used for any removable battery pack 10 and energy storage cells 42.

For monitoring the individual energy store cells 42 connected in series, or the cell clusters of the removable battery pack 10, a single-cell monitoring (SCM) pre-stage 44 is provided. The SCM pre-stage 44 comprises a multiplexer measuring device 46 which, via filter resistors 48, can be connected at a high impedance level to corresponding taps 50 of the poles of the energy store cells 42 or cell clusters. In the following, the term “energy store cell” is also intended to include the cell cluster, because it only affects the capacity of the removable battery pack 10, but is equivalent with regard to the detection of cell voltages U_{Cell}. The filter resistors 50, which are in particular designed at a high impedance level, can in particular prevent dangerous heating of the measurement inputs of the multiplexer measuring device 46 in the event of a fault.

The switching of the multiplexer measuring device 46 can be performed via a monitoring unit 52 integrated into the removable battery pack 10 or also directly within the SCM pre-stage 44. Additionally, in this way, switching elements 54 of the SCM pre-stage 44 connected in parallel to the energy store cells 42 can be closed or opened in order to thus effect what is referred to as balancing of the energy store cells 42 in order to achieve uniform charge and/or discharge states of the individual energy store cells 42. It is likewise conceivable that the SCM pre-stage 44 passes the measured cell voltages U_{Cell} to the monitoring unit 52 so that the actual measurement of the cell voltages U_{Cell} is performed directly by the monitoring unit 52, e.g., via a corresponding analog-digital converter (ADC).

The monitoring unit 52 can be designed as an integrated circuit in the form of a microprocessor, ASIC, DSP, or the like. It is likewise conceivable that the monitoring unit 52 consists of a plurality of microprocessors or at least in part of discrete components having corresponding transistor logic. In addition, the first monitoring unit 52 can comprise a memory for storing operating parameters of the removable battery pack 10, such as the voltage U_{Batt}, the cell voltages U_{Cell}, a temperature T, the charging or discharging current I, or the like.

In addition to the monitoring unit 52 in the removable battery pack 10, the charging device 16 or the electrical consumer 18 can also comprise a monitoring unit 56, which can be designed according to the monitoring unit 52 of the removable battery pack 10. In the case of an electrical consumer 18, the monitoring unit 56 controls a load 58 connected to the first and the second power supply contacts 38, 40 of the further interface 20, which is adjacent the removable battery voltage U_{Batt}. The load 58 can, e.g., be designed as a power output stage that applies a pulse-width modulated signal to an electric motor to change its rotational speed and/or torque, which has a direct effect on the discharging current I of the removable battery pack 10. However, a load 58 that converts power is also conceivable. Numerous variants of possible electrical or electromechanical loads are known to the skilled person, so this will not be discussed in further detail.

Alternatively, the removable battery pack 10 inserted into a charging device 16 can be charged at the charging current I and the voltage U_{Batt} corresponding to the removable battery pack 10. For this purpose, the charging device 16 or its mains adapter 60 is provided with a mains connection (not shown). The voltage U_{Batt} applied to the energy supply contacts 38, 40 can be measured via a voltage measuring device 62 in the charging device 16 and evaluated by the monitoring unit 56. The voltage measuring device 62 can also be fully or partially integrated into the monitoring unit 56 of the charging device 16, e.g., in the form of an integrated ADC. The exact design of the mains adapter 60 of the charging device 16 is known to the skilled person and is of minor importance to the invention. Therefore, it will not to be discussed further herein.

A temperature sensor 66 arranged in the removable battery pack 10, which is preferably designed as an NTC and is in close thermal contact with at least one of the energy storage cells 42, is used to measure a temperature T of the removable battery pack 10 or the energy store cells 42 by means of a measuring circuit 64 integrated into the removable battery pack 10. The temperature T measured in this way can then be evaluated by the monitoring unit 56 of the charging device 16 or the electrical consumer 18 via a first contact 12 of the electromechanical interfaces 14, 20 designed as a signal contact or data contact 68.

In order for the charging device 16 or the electrical consumer 18 to identify and possibly release the removable battery pack 10 for charging or discharging, the removable battery pack 10 comprises a coding resistor 70, which is connected to the measuring circuit 64 in a manner similar to the temperature sensor 66. The resistance value of the coding resistor 70 measured using the measuring circuit 66 can then be evaluated by the monitoring unit 56 of the charging device 16 or the electrical consumer 18 across a further contact 12 of the interfaces 14 designed as a signal contact or data contact 72. If the resistance value of the coding resistor 70 matches a value stored in the monitoring unit 56 of the charging device 16, then charging operation is started according to the charging parameters stored in a look-up table, in particular the charging current I, the charging voltage U_{Batt}, the permitted temperature range, etc. Accordingly, the discharge operation of the removable battery pack 10 can also be released by the monitoring device 56 of the electrical consumer 18. Instead of only one coding resistor 70, a plurality of coding resistors can also be provided in the removable battery pack 10 for the charging and discharging operation. If the measured resistor values of the coding resistors do not match the values according to the look-up table, the charging or discharging operation of the battery pack 10 is canceled or not allowed. Particularly advantageously, this enables the operation of removable battery packs 10 of different power classes having the same electromechanical interfaces 14 and 20.

In order to also interrupt or enable the charging or discharging current I to increase the operational reliability within the removable battery pack 10, the removable battery pack 10 comprises at least a first switching element 74, which can be closed by the monitoring unit 52 for interrupting the charging or discharging current I and opened for enabling the charging or discharging current I. In the exemplary embodiment shown, the at least one first switching element 74 is arranged in the ground path (low side) between the second contact 12 designed as the power supply contact 40 of the electromechanical interface 14 and a ground contact point 76 of the SCM pre-stage 44. However, it is also conceivable that the at least one first switching element 74 be arranged in the supply path (high side) between the first contact 12 designed as the power supply contact 38 and the tap 50 of the SCM pre-stage 44 be designed as the supply contact point. Likewise, at least one first switching element 74 can be provided in both the supply path and the ground path. Preferably, the at least one first switching element 74 is designed as a MOSFET. However, other switching elements, such as a relay, an IGBT, a bipolar transistor, or the like, are also conceivable.

Given the charging or discharging current I and the resulting current gradient, there are in principle voltage drops U L across various ohmic-inductive loads in the removable battery pack 10. These loads are indicated in FIG. 1 by respective replacement impedances 78 and 80. While the replacement impedance 78 symbolizes all ohmic-inductive loads within the removable battery pack 10, such as printed circuit board traces, cables, current sensing resistors, fuses, semiconductor transitions, etc., the replacement impedance 80 indicates the losses through the electrical connection between the at least one first switching element 74 and the second contacts 12 of the electromechanical interface 14 designed as the power supply contact 40. In addition, there is also a voltage drop U_{L} across the at least one first switching element 74. The double arrows indicate that the voltage drops U_{L} are dependent on the direction of current (charging or discharging current). In the case of a discharging current I, the current flows in on the ground side into the removable battery pack, while in the case of a charging current I, it flows out on the ground side. Accordingly, the voltage drops U_{L} result.

The voltage drops U_{L} effect a ground shift between the charging device 16 or electrical consumer 18 and the electronics of the removable battery pack 10. In other words, the second reference potential V₂ or the ground potential GND of the removable battery pack 10 deviates from the second reference potential V₂ or ground potential GND of the charging device 16 or the electrical consumer 18 by the sum of the voltage drops ΣU_{L}. This ground shift, which is dependent on the charging or discharging current I, causes a measurement error in the measurement of the temperature sensor 66 and the coding resistor 70, as well as other possible components being measured. The measuring circuit 64 is then connected to the second contact 12 designed as a power supply contact 40 such that the measurement of the temperature sensor 66 and the coding resistor 70 as well as possibly further integrated components takes place substantially independently of the charging or discharging current I of the removable battery pack 10. Given the proximity of the ground-side connection of the components being measured to the corresponding power supply contact 40 of the electromechanical interface 14, undesirable voltage drops within the measuring loop, and thus a reliable determination of the charging or discharging parameters, can be enabled at any desired charging or discharging currents I. Instead of a common ground connection of the components being measured, it is alternatively possible to equip individual or all components being measured with a separate ground connection. It is also conceivable that the measuring circuit 64 comprise a multiplexer, by means of which it drives the individual components being measured, in particular the temperature sensor 66 and the coding resistor 70, and achieves the respective ground connections. The control of such a multiplexer can be accomplished via the monitoring unit 52 of the removable battery pack 10 and/or via the monitoring unit 56 of the charging device 16 or electrical consumer 18. The construction of a multiplexer is known to the skilled person and will therefore not be explained further at this point. The multiplexer within the measuring circuit also enables the number of the electromechanical interfaces 14, 20 designed as signal contacts or data contacts 12 to be reduced, in particular to only one such contact 12.

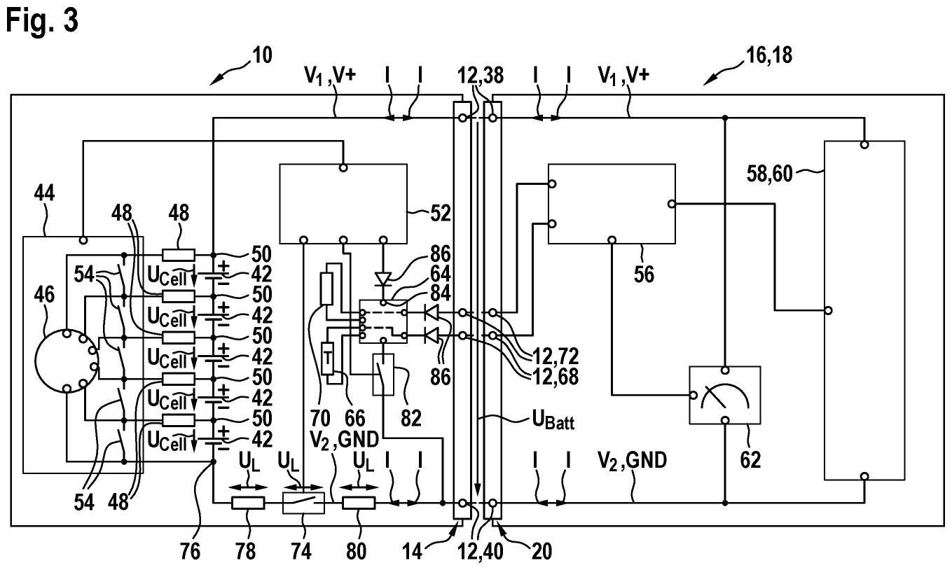

If the at least one first switching element 74 is opened for interrupting the charging or discharging current, there is a risk of a permanently high voltage drop U_{L} across the at least one first switching element 74, which can reach up to the level of the removable battery voltage U_{Batt}, e.g., when an external load is connected to the electromechanical interface 14, e.g., an electrical consumer 18 or a charging device 16. Due to inductive components in the current path, the voltage drop U_{L} can also be significantly higher for a short time after the opening of the at least one first switching element 74. Such a high voltage drop U_{L} can lead to damage or functional impairments in the removable battery pack 10 and/or in the charging device 16 or in the electrical consumer 18. In order to avoid such a drop in voltage, it is provided according to FIG. 3 that at least one further switching element 82 is provided between the measuring circuit 64 and the second contact 12 designed as a power supply contact 40 in order to avoid a current flow proceeding from the second reference potential V₂, in particular the ground potential GND, into the measuring circuit 64 or from the measuring circuit 64 towards the second reference potential V₂, in particular the ground potential GND. In addition, risks can be avoided that could interfere with the functionality of the removable battery pack 10, charging device 16, and/or electrical consumer 18.

The at least one further switching element 82 is controlled via the monitoring unit 52 of the removable battery pack 10 such that, in conjunction with the at least one first switching element 74, it interrupts or enables the charging or discharging current I. The monitoring unit 52 in this case disconnects the measuring circuit 64 from the second reference potential V₂, in particular from the ground potential GND, by opening the at least one further switching element 82 in a time-dependent manner before the at least one first switching element 74 in order to protect the measuring circuit 64 against excessive voltages. It is further provided that the monitoring unit 52 closes the at least one further switching element 82 in a time-dependent manner after the at least one first switching element 74 in order to ensure that, after closing the at least one first switching element 74, any voltage that drops across it can first degrade. Preferably, the at least one further switching element 82 is designed as a MOSFET. However, other switching elements, such as a relay, an IGBT, a bipolar transistor, or the like, are also conceivable.

Instead of or in addition to the at least one further switching element 82, a control input 84 of the measuring circuit 64 can be decoupled from the monitoring unit 52 by a protection element 86, in particular a protection diode. other components of the removable battery pack 10 connected to the measuring circuit 64 can be protected against excessive voltages or voltage spikes in this way. It is also conceivable that these components and/or the measuring circuit 64 itself be designed from the outset such that they can absorb these high voltages.

It is also possible to decouple the at least one further contact 12 designed as a signal contact or data contact 68, 72 of the electromechanical interface 14 by a protection element 86, in particular a protection diode, in order protect devices externally connected via the signal contacts or data contacts 68, 72, e.g., the charging device 16, the electrical consumers 18, or even a diagnostic device (not shown) against excessive voltages or voltage spikes of the removable battery pack 10. Alternatively or additionally, corresponding protection elements can also be connected to the signal contact or data contacts 68, 72 of the electromechanical interface 20 of the charging device 16 or the electrical consumer 18.

Finally, it should be noted that the exemplary embodiments shown are not limited to FIGS. 1 to 3, nor to the type of removable battery packs 10, charging devices 16, or electrical consumers 18 shown therein. The same applies to the number of energy store cells 46 and the associated configuration of the multiplexer measuring device 46. In addition, the embodiments of the interfaces 14, 20 and the number of their contacts 12 shown are merely to be understood as an example. The same is true of the type and number of temperature sensors and coding resistors.

1. A removable battery pack comprising:
an electromechanical interface including a plurality of electrical contacts, wherein (i) a first electrical contact is configured as a first power supply contact to which a first reference potential is applied, and (ii) a second electrical contact is configured as a second power supply contact to which a second reference potential is applied, the electromechanical interface further including at least one first switching element configured to interrupt or enable a charging or discharging current across the first and the second power supply contacts; and
a measuring circuit configured to measure integrated components, which are integrated in the removable battery pack, via at least one further contact of the plurality of electrical contacts, the at least one further contact is configured as a signal contact or data contact,
wherein the measuring circuit is interconnected with the second power supply contact, such that the integrated components are measured substantially independently of the charging or discharging current.

2. The removable battery pack according to claim 1, further comprising:
a monitoring unit configured (i) to open the at least one first switching element, which is interconnected with the second reference potential, for interrupting the charging or discharging current, and (ii) to close the at least one first switching element for enabling the charging or discharging current.

3. The removable battery pack according to claim 1, further comprising:
at least one further switching element operably connected between the measuring circuit and the second power supply contact in order to avoid a current flow proceeding from the second reference potential into the measuring circuit or from the measuring circuit towards the second reference potential.

4. The removable battery pack according to claim 3, wherein the monitoring unit is configured to open the at least one further switching element in a time-dependent manner before the at least one first switching element.

5. The removable battery pack according to claim 3, wherein the monitoring unit is configured to close the at least one further switching element in a time-dependent manner after the at least one first switching element.

6. The removable battery pack according to claim 1, further comprising:
a protection element configured to decouple at least one control input of the measuring circuit from the monitoring unit.

7. The removable battery pack according to claim 1, further comprising:
a protection element configured to decouple the at least one further contact.
